(19) United States
(12) Patent Application Publication
(10) Pub. No.: US 2009/0047373 A1
(43) Pub. Date: Feb. 19, 2009

(54) Bridge Runner System

(75) Inventors: John Robert Galt, Nobleton (CA); Thomas Michael McGinley, Caledon (CA); Sheldon John Alexander, Alburgh, VT (US); Christopher J. Brusa, Raleigh, NC (US); Stephen Daniel Ferenc, Bolton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/840,107

(22) Filed: Aug. 16, 2007

(51) Int. Cl. B29C 49/06

(52) U.S. Cl. 425/524; 425/538; 425/541

(57) ABSTRACT

Disclosed herein is a stationary platen of a mold clamp for use with a molding system. The stationary platen includes a platen base configured to accept a first mold assembly of a mold, the platen base also defines a receptacle for embedding, in use, a bridge runner system. The bridge runner system is configured to fluidly connect, at least in part, a source of molding material with a molding cavity defined, at least in part, by a mold insert accepted in the first mold assembly.

### FIELD OF THE INVENTION

The present invention generally relates to a molding system, and more specifically the present invention relates to a stationary platen with an embedded bridge runner system, and a platen coupling interface.

### BACKGROUND

Molding is a process by virtue of which a molded article can be formed from molding material by using a molding system. Various molded articles can be formed by using the molding process, such as an injection molding process. One example of a molded article that can be formed, for example, from polyethelene terephthalate (PET) material is a preform that is capable of being subsequently blown into a beverage container, such as, a bottle and the like.

As an illustration, injection molding of PET material involves heating the PET material (ex. PET pellets, PEN powder, PLA, etc.) to a homogeneous molten state and injecting, under pressure, the so-melted PET material into a molding cavity defined, at least in part, by a female cavity piece and a male core piece mounted respectively on a cavity plate and a core plate of the mold. The cavity plate and the core plate are urged together and are held together by clamp force, the clamp force being sufficient enough to keep the cavity and the core pieces together against the pressure of the injected PET material. The molding cavity has a shape that substantially corresponds to a final cold-state shape of the molded article to be molded. The so-injected PET material is then cooled to a temperature sufficient to enable ejection of the so-formed molded article from the mold. When cooled, the molded article shrinks inside of the molding cavity and, as such, when the cavity and core plates are urged apart, the molded article tends to remain associated with the core piece. Accordingly, by urging the core plate away from the cavity plate, the molded article can be demolded, i.e. ejected off of the core piece. Ejection structures are known to assist in removing the molded articles from the core halves. Examples of the ejection structures include stripper plates, ejector pins, etc.

### SUMMARY

In a first aspect of the present invention, there is provided a stationary platen of a mold clamp for use with a molding system. The stationary platen includes a platen base configured to accept a first mold assembly of a mold, the platen base also defines a receptacle for embedding, in use, a bridge runner system. The bridge runner system is configured to fluidly connect, at least in part, a source of molding material with a molding cavity defined, at least in part, by a mold insert accepted in the first mold assembly.

In a second aspect of the present invention, there is provided a molding system. The molding system includes a stationary platen, a movable platen, a clamping mechanism, and an injection unit. The stationary platen includes a platen base configured to accept a first mold assembly of a mold, the platen base defining a receptacle for embedding, in use, a bridge runner system that is configured to fluidly connect a source of molding material with the mold. The movable platen configured to accept, in use, a second mold assembly of the mold. The clamping mechanism configured to clamp, in use, the mold. The injection unit as a source of molding material for fluid connection, in use, with the mold.

In a third aspect of the present invention, there is provided a bridge runner system. The bridge runner system includes a bridge network of runners that are configured to fluidly connect, in use, a source of molding material with a mold network of runners. The bridge network of runners configured to be embedded, in use, in a stationary platen of the molding system.

In a fourth aspect of the present invention, there is provided a platen coupling interface defined on a first mold assembly of a mold for releasably securing, in use, the first mold assembly to a stationary platen of a molding system having a bridge runner system embedded therein. The platen coupling interface includes a platen mounting interface configured to cooperate, in use, with a complementary mold mounting interface associated with the stationary platen for releasably mounting the first mold assembly to the stationary platen, and a bridge runner system coupling interface configured to cooperate, in use, with a mold runner system coupling interface defined, at least in part, by the bridge runner system for fluid connecting a mold network of runners defined in the first mold assembly with a bridge network of runners defined in the bridge runner system.

### DESCRIPTION OF THE DRAWINGS

A better understanding of the embodiments of the present invention (including alternatives and/or variations thereof) may be obtained with reference to the detailed description of the embodiments along with the following drawings, in which:

FIG. 1 is a schematic representation of a molding system according to a non-limiting embodiment of the present invention;

FIGS. 2A and 2B are front views of a complementary first and a second mold assemblies of an injection mold mounted to a stationary platen and a movable platen, respectively, of the molding system in accordance with FIG. 1;

FIG. 3A is a front perspective view of the first mold assembly in accordance with FIG. 2;

FIG. 3B is a front perspective view of the second mold assembly in accordance with FIG. 2;

FIG. 4 is a rear perspective view of the first mold assembly in accordance with FIG. 2;

FIG. 5A is a front perspective view of a first mold assembly in accordance with another non-limiting embodiment of the present invention;

FIG. 5B is a front perspective view of a first mold assembly in accordance with yet another non-limiting embodiment of the present invention;

FIG. 5C is a front perspective view of a first mold assembly in accordance with a further non-limiting embodiment of the present invention;

FIG. 6 is a schematic representation of a network of runners in accordance with a non-limiting embodiment of the present invention;

FIG. 7 is a side view of the first mold assembly of FIG. 5A mounted to the stationary platen having an injection unit, schematic representations shown in section, the stationary platen including a bridge runner system in accordance with a non-limiting embodiment of the present invention embedded in a front portion thereof;

FIG. 8 is a side view of the first mold assembly of FIG. 5A mounted to the stationary platen having an injection unit, schematic representations shown in section, the stationary platen includes a bridge runner system in accordance with a non-limiting embodiment of the present invention embedded in a rear portion thereof;

FIG. 9 is a side view of the first mold assembly in accordance with FIG. 5A mounted to the stationary platen having a pair of injection units, schematic representations shown in section;

FIG. 10 is a front perspective view of a first mold module of the first mold assembly, the bridge runner system, and the stationary platen in accordance with FIG. 7;

FIG. 11 is a partial section view of the first mold assembly, stationary platen and bridge runner system in accordance with FIG. 7;

FIG. 12 is a front perspective view of an end-of-arm tool according to a non-limiting embodiment of the present invention for use in the molding system in accordance with FIG. 1;

FIG. 13 is a front perspective view of a first mold module of a first mold assembly in accordance with another non-limiting embodiment of the present invention arranged on a fourth mold base module, a bridge runner system according to another non-limiting embodiment of the present invention arranged in the fourth mold base module;

FIG. 14 is a rear perspective view of the first mold module in accordance with FIG. 13;

FIG. 15 is a front perspective view of a second mold module of a second mold assembly in accordance with a non-limiting embodiment of the present invention.

The drawings are not necessarily to scale and are may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EMBODIMENTS

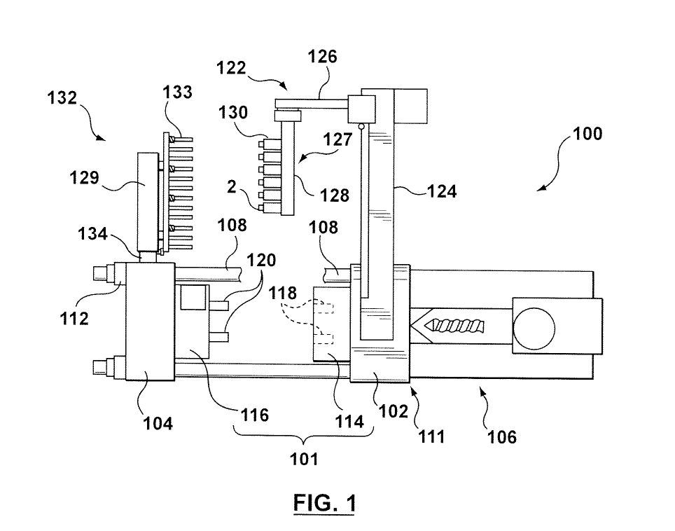

With reference to FIG. 1, there is depicted a non-limiting embodiment of a molding system 100 which can be adapted to implement embodiments of the present invention. For illustration purposes only, it shall be assumed that the molding system 100 comprises an injection molding system for processing molding material, such as, PET for example.

Within the non-limiting embodiment of FIG. 1, the molding system 100 comprises a mold clamp unit 111 having a stationary platen 102 and a movable platen 104 for receiving a first mold assembly 114 and a second mold assembly 116, respectively, of a mold 101. The molding system 100 further comprises an injection unit 106 for plasticizing and injection of molding material. In operation, the movable platen 104 is moved towards and away from the stationary platen 102 by means of stroke cylinders (not shown) or any other suitable means. Clamp force (also referred to as closure or mold closure tonnage) can be developed within the molding system 100, for example, by using tie bars 108 and a clamping mechanism 112, as well as (typically) associated hydraulic system (not depicted) that is usually associated with the clamping mechanism 112. It will be appreciated that clamp tonnage can be generated using alternative means, such as, for example, using a toggle-clamp arrangement (not depicted) or the like.

The mold 101 is depicted having the first mold assembly 114 associated with the stationary platen 102 and the second mold assembly 116 associated with the movable platen 104. In the specific non-limiting embodiment of FIG. 1, the mold 101 is configured for the production of preforms 2 (FIG. 1) of the type that are subsequently blow molded into bottles, and the like, in accordance with a further blow molding process as is known to those of skill in the art. In the specific non-limiting embodiment of FIG. 1, the first mold assembly 114 comprises one or more first mold inserts 118. The second mold assembly 116 comprises one or more second mold inserts 120.

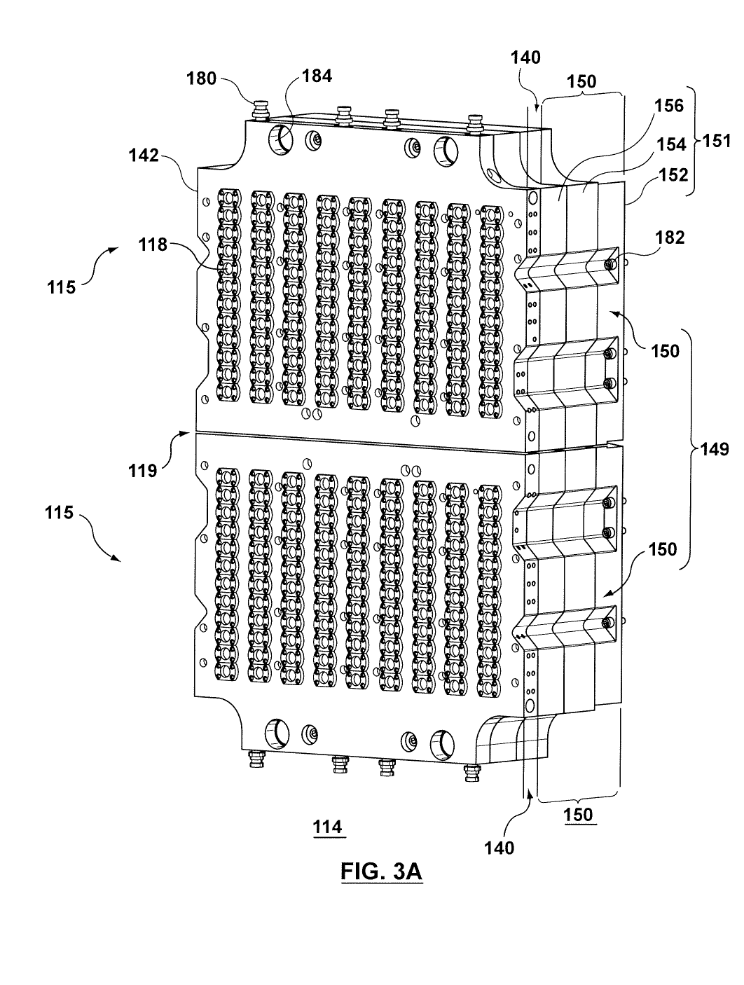

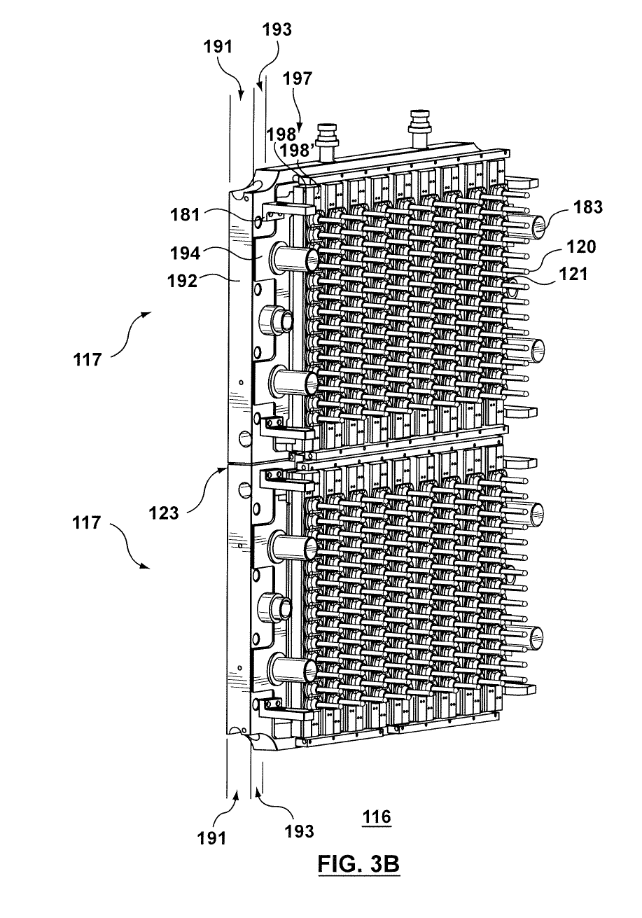

The first mold assembly 114 can be coupled to the stationary platen 102 by any suitable means, such as a suitable fastener 182 (FIG. 3A) or the like. Likewise, the second mold assembly 116 can be similarly coupled to the movable platen 104. It should be understood that in alternative non-limiting embodiment of the present invention, the position of the first mold assembly 114 and the second mold assembly 116 can be reversed and, as such, the first mold assembly 114 can be associated with the movable platen 104 and the second mold assembly 116 can be associated with the stationary platen 102.

In alternative non-limiting embodiments of the present invention, the stationary platen 102 need not be stationary and may as well be moved in relation to other components of the molding system 100.

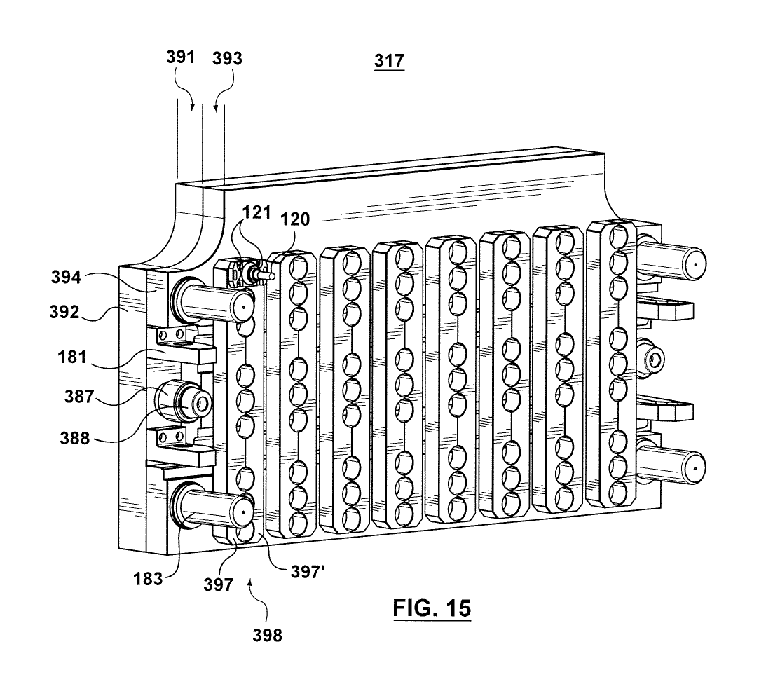

FIG. 1 depicts the first mold assembly 114 and the second mold assembly 116 in a so-called “mold open position” where the movable platen 104 is positioned generally away from the stationary platen 102 and, accordingly, the first mold assembly 114 is positioned generally away from the second mold assembly 116. For example, in the mold open position, a molded article (not depicted) can be removed from the first mold assembly 114 and/or the second mold assembly 116. In a so-called “mold closed position” (not depicted), the first mold assembly 114 and the second mold assembly 116 are urged together (by means of movement of the movable platen 104 towards the stationary platen 102 and cooperate to define (at least in part) a molding cavity (not depicted) into which the molten plastic (or other suitable molding material) can be injected, as is known to those of skill in the art. It should be appreciated that one of the first mold assembly 114 and the second mold assembly 116 can be associated with a number of additional mold elements, such as for example, one or more leader pins 183 (FIGS. 3B, 15) and one or more leader bushings 383 (FIG. 15), the one or more leader pins cooperating with one more leader bushings to assist in alignment of the first mold assembly 114 with the second mold assembly 116 in the mold closed position, as is known to those of skill in the art.

The molding system 100 can further comprise a robot 122 operatively coupled to the stationary platen 102. Those skilled in the art will readily appreciate how the robot 122 can be operatively coupled to the stationary platen 102 and, as such, it will not be described here in any detail. The robot 122 comprises a mounting structure 124, actuating arm 126 coupled to the mounting structure 124 and an end-of-arm tool 127 coupled to the actuating arm 126. The end-of-arm tool further comprises molded article receptacles 130. Generally speaking, the purpose of the plurality of molded article receptacles 130 is to hold molded articles received from the one or more first mold inserts 118 and second mold inserts 120 of the mold 101 and/or to implement post mold cooling of the molded articles. In the specific non-limiting example being illustrated herein, the plurality of molded article receptacles 130 are configured for receiving molded articles in the form of preforms 2. However, it should be expressly understood that the plurality of molded article receptacles 130 may have other configurations. The exact number of the plurality of molded article receptacles 130 is not particularly limited. For example, if a four-position post mold cooling cycle is to be implemented and if the molding system 100 comprises two-hundred and sixteen instances of the one or more first mold inserts 118, the end-of-arm tool plate 128 can comprise eight hundred and sixty-four instances of the plurality of molded article receptacles 130. Other configurations are, of course, also possible and are only limited by business considerations of an entity managing the molding system 100.

The molding system 100 further comprises a treatment device 132 operatively coupled to the movable platen 104. Those skilled in the art will readily appreciate how the treatment device 132 can be operatively coupled to the movable platen 104 and, as such, it will not be described here in any detail. The treatment device 132 comprises a mounting structure 134 used for coupling the treatment device 132 to the movable platen 104. The treatment device 132 further comprises a plenum 129 coupled to the mounting structure 134. Coupled to the plenum 129 is a plurality of treatment pins 133. The number of instances of the plurality of treatment pins 133 generally corresponds to the number of instances of the plurality of molded article receptacles 130.

Generally speaking, the purpose of the plenum 129 is to supply services (such as, for example, vacuum and/or air stream) to the plurality of treatment pins 133. In some embodiments of the present invention, the plenum 129 can further comprise a rotating mechanism (not separately depicted in FIG. 1) that rotates the plenum 129 relative to the movable platen 104 to dislodge molded articles disposed on at least some of the plurality of treatment pins 133. Accordingly, the purpose of the plurality of treatment pins 133 can include some or all of: (i) engaging molded articles received in the plurality of molded article receptacles 130 and to provide air to cool the molded articles from within; (ii) to remove the molded articles from the plurality of molded article receptacles 130; and (iii) to eject the molded articles onto a conveyor belt or onto any other suitable means. It should be noted that some of the plurality of treatment pins 133 may perform some or all of the functions recited above. For example, in some embodiments of the present invention, certain occurrences of the plurality of treatment pins 133 may exclusively execute a cooling function, while others may exclusively execute an ejection function. In alternative non-limiting embodiments of the present invention, all instances of the plurality of treatment pins 133 may perform both the cooling and the ejection functions.

Naturally, the molding system 100 may comprise a number of additional components, such as auxiliary equipment (not depicted), such as dehumidifiers, heaters and the like. All this equipment is known to those of skill in the art and, as such, will not be discussed at any length here. It should be expressly understood that the molding system 100 may have other configurations and the description presented above has been provided as an example only and is not intended to be limiting in any form. In other non-limiting embodiments of the present invention, the molding system 100 can have other configurations with more or fewer components.

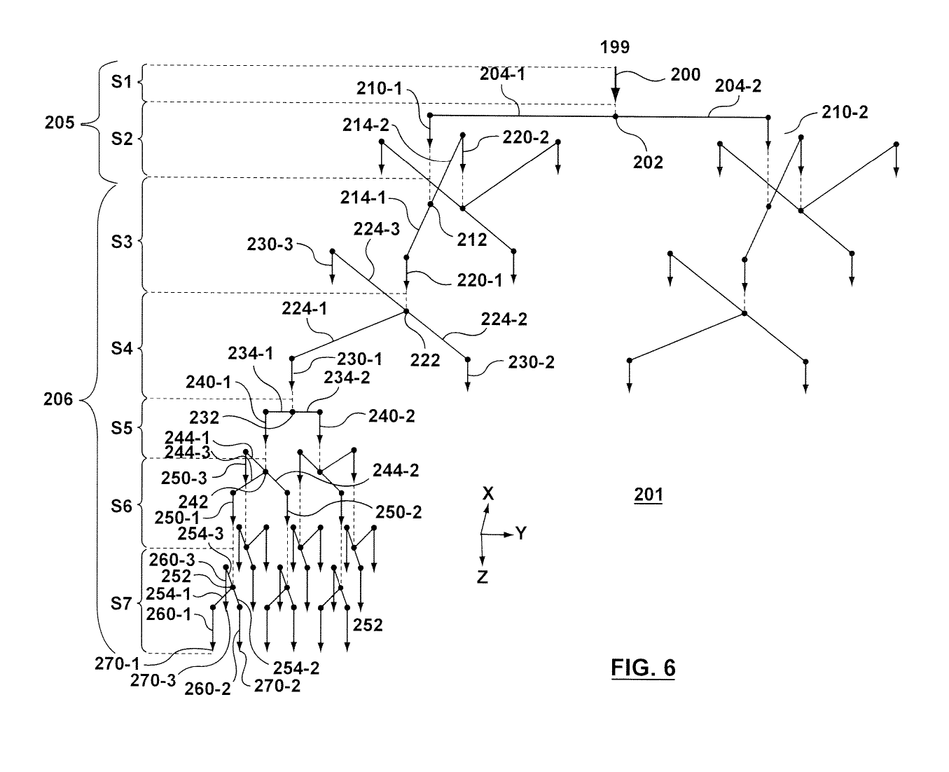

In accordance with an aspect of the present invention a melt distribution apparatus is provided for the molding system 100. With reference to FIG. 6, a non-limiting embodiment of the melt distribution apparatus is depicted that includes a geometrically balanced network of runners 201 defined between a melt inlet 199 and two-hundred and sixteen melt outlets 270 (only some of which are shown in FIG. 6). The geometrically balanced network of runners 201 is typically embodied in a runner system 149, 349 as will be described in detail to follow. Those skilled in the art of injection mold tool and molding system design have heretofore designed injection molds to have a mold cavity layout with the mold cavities arranged in a rectangular array of even numbered columns and rows whenever the number of rows or columns was in excess of three because of an inability to provide a network of runners that was geometrically balanced. By ‘geometric balance’, the inventors refer to the common practice of configuring the network of runners in the network of runners to have more or less the same flow length between a common melt inlet to a plurality of melt outlets fluidly connected to a plurality of molding cavities within the injection mold. For example, in accordance with the currently accepted approach to mold runner system design, a proposed injection mold having two-hundred and sixteen cavities would include a rectangular array of melt outlets, or drops, with eighteen rows and twelve columns. As will be easily appreciated a mold runner system with an even number of columns is necessarily wider than a similar mold runner system having the same number of melt outlets and spacing between melt outlets (i.e. pitch) but with one less column (i.e. an odd number of columns). There is a productivity penalty associated with the wider melt runner system, and hence injection mold, in that the end of arm tool must travel further into the space between the first and second mold assemblies 114, 116 to retrieve the molded articles thus consuming more time in doing so.

The inventors have discovered that in fact it is possible to define a geometrically balanced network of runners 201 to interconnect the melt inlet 199 with the rectangular array of melt outlets 270 having an odd number of columns in excess of three. More particularly, a geometrically balanced network of runners 201 may be provided for distributing a melt of molding material from a melt inlet 199 to a rectangular array of melt outlets 270 having a first number of melt outlets 270 in a first reference direction X and a second number of melt outlets 270 in a second reference direction Y, at least one of the first and the second number being an odd number in excess of three. A technical effect of the foregoing may include improved system productivity owing to a reduced stroke requirement for end-of-arm tool 127. More particularly, by having made the mold 101 narrower with the odd number of rows of molding cavities, the distance traveled by the end-of-arm tool 127 between an in-mold and an out-of-mold position, and hence the time required to move, may be shortened. For example, in accordance with the non-limiting embodiment having two-hundred and sixteen 216) melt outlets 270, the network of runners 201 made it possible to reduce the width of the mold from twelve (12) rows to only nine (9) for a twenty five percent (25%) reduction in mold width.

The geometrically balanced network of runners 201 includes a cascade arrangement of branch and drop runners that are arranged in tiers with the drop runners interconnecting the branch runners of successive tiers, such that the total number of drop runners in each successive tier being a mathematical factor of the total number of the melt outlets 270 in the rectangular array. With reference to FIG. 6 and Table 1 below, where the total number of drop runners in each successive tier S1, S2, S3, S4, S5, S6, S7 of a seven-tier cascade, beginning at the melt inlet 199 of the first tier S1 and ending at the melt outlets 270, is a mathematical product of the total number of drop runners in a preceding tier and a successive one of the mathematical factors in a numeric series comprising one, two, two, three, two, three & three, respectively, such that a melt of molding material entering the melt inlet 199 is split between two-hundred and sixteen melt outlets 270 arranged in a rectangular array with nine melt outlets 270 in the first reference direction X and twenty four melt outlets 270 in the second reference direction Y.

TABLE 1

| | # drops in First | # drops in Second | | Total number |
|---|---|---|---|---|
| Tier | Direction X | Direction Y | Factor | of drops |
| S1 | 1 | 1 | 1 | 1 |
| S2 | 1 | 2 | 2 | 2 |
| S3 | 2 | 2 | 2 | 4 |
| S4 | 3 | 4 | 3 | 12 |
| S5 | 3 | 8 | 2 | 24 |
| S6 | 6 | 12 | 3 | 72 |
| S7 | 9 | 24 | 3 | 216 |

For example, the seven-tier cascade includes a first tier S1 having a first drop runner 200 that is located in the centre of the rectangular array of melt outlets 270 and aligned with a third reference direction Z that is orthogonal to the first and second reference directions X, Y, the first drop runner 200 having a melt inlet 199 disposed at an end thereof, the first drop runner 200 terminating at a junction 202. Next, the seven-tier cascade drops to a second tier S2 having a pair of second branch runners 204-1, 204-2 of equal length radiating in opposite directions from the junction 202 aligned with the first reference direction X, a pair of second drop runners 210-1, 210-2 of equal length aligned with the third reference direction Z connected at ends of the second branch runners 204-1, 204-2, respectively, and each terminating at a respective junction 212. Next, the seven-tier cascade drops to a third tier S3 having a pair of third branch runners 214-1, 214-2 of equal length radiating in opposite directions from each junction 212 aligned with the second reference direction Y, and a pair of third drop runners 220-1, 220-2 of equal length aligned with the third reference direction Z connected at ends of the third branch runners 214-1, 214-2, respectively, and each terminating at a respective junction 222. Next, the seven-tier cascade drops to a fourth tier S4 having a set of three fourth branch runners 224-1, 224-2, 224-3 of equal length radiating in a Y-shape from each junction 222 and oriented between the first and second reference directions X, Y with ends thereof arranged in a fourth tier rectangular array aligned with the first and second reference directions X, Y, and a set of three fourth drop runners 230-1, 230-2, 230-3 of equal length aligned with the third reference direction Z connected at the ends of the fourth branch runners 224-1, 224-2, 224-3, respectively, and each terminating at a respective junction 232. Next, the seven-tier cascade drops to a fifth tier S5 having a pair of fifth branch runners 234-1, 234-2 of equal length radiating in opposite directions from each junction 232 aligned with the first reference direction X, and a pair of fifth drop runners 240-1, 240-2 of equal length aligned with the third reference direction Z connected at ends of the fifth branch runners 234-1, 234-2, respectively, and each terminating at a respective junction 242. Next, the seven-tier cascade drops to a sixth tier S6 having a set of three sixth branch runners 244-1, 244-2, 244-3 of equal length radiating in a Y-shape from each junction 242 and oriented between the first and second reference directions X, Y with ends thereof arranged in a sixth tier rectangular array aligned with the first and second reference directions X, Y, and a set of three sixth drop runners 250-1, 250-2, 250-3 of equal length aligned with the third reference direction Z connected at the ends of the sixth branch runners 244-1, 244-2, 244-3, respectively, and each terminating at a respective junction 252. Next, the seven-tier cascade drops to a seventh tier S7 having a set of three sixth branch runners 254-1, 254-2, 254-3 of equal length radiating in a Y-shape from each junction 252 and oriented between the first and second reference directions X, Y with ends thereof arranged in the rectangular array of the melt outlets 270, and a set of three seventh drop runners 260-1, 260-2, 260-3 of equal length aligned with the third reference direction Z connected at the ends of the seventh branch runners 254-1, 254-2, 254-3, respectively, the rectangular array of melt outlets 270 disposed at the end of the seventh drop runners 260-1, 260-2, 260-3. In accordance with the foregoing, the total number of drop runners in each successive tier S2, S3, S4, S5, S6, S7 of the seven-tier cascade, beginning at the first drop runner 200 of the first tier S1, increases to two of the second drop runners 210-1, 210-2 at the second tier S2, increases to six of the third drop runners 220-1, 220-2 at the third tier S3, increases to eighteen of the fourth drop runners 230-1, 230-2, 230-3 at the fourth tier S4, increases to thirty-six of the fifth drop runners 240-1, 240-2 at the fifth tier S5, increases to one-hundred and eight of the sixth drop runners 250-1, 250-2, 250-3 at the sixth tier S6, and, lastly, increases to two-hundred and sixteen of the seventh drop runners 260-1, 260-2, 260-3 at the seventh tier S7, respectively, whereby the melt inlet 199 is connected to two-hundred and sixteen melt outlets 270 arranged in the rectangular array having the first number of melt outlets 270 in the first reference direction X being nine and the second number of melt outlets 270 in the second reference direction Y being twenty-four.

In accordance with a further non-limiting embodiment, reference Table 2 below, the melt distribution apparatus may be defined such that the total number of drop runners in each successive tier S1′, S2′, S3′, S4′, S5′, S6′ of a six-tier cascade, beginning at the melt inlet 199 of a first tier S1′ and ending at the melt outlets 270, is a mathematical product of the total number of drop runners in a preceding tier and a successive one of the factors in a numeric series comprising one, four, three, two, three, and three, respectively, such that a melt of molding material entering the melt inlet 199 is split between two-hundred and sixteen melt outlets 270 arranged in a rectangular array with nine melt outlets 270 in the first reference direction X and twenty four melt outlets 270 in the second reference direction Y.

TABLE 2

| | # drops in First | # drops in Second | | Total number |
|---|---|---|---|---|
| Tier | Direction X | Direction Y | Factor | of drops |
| S1′ | 1 | 1 | 1 | 1 |
| S2′ | 2 | 2 | 4 | 4 |
| S3′ | 3 | 4 | 3 | 12 |
| S4′ | 3 | 8 | 2 | 24 |
| S5′ | 6 | 12 | 3 | 72 |
| S6′ | 9 | 24 | 3 | 216 |

The rectangular array of melt outlets 270 are arranged with a constant spacing (i.e. pitch) between adjacent melt outlets 270 in the first and second reference directions X, Y (i.e. columns and rows), respectively. Alternatively, the melt outlets 270 of the rectangular array of melt outlets 270 may be arranged with a split pitch having a disrupted spacing, at least in part, between adjacent melt outlets 270 in the first and second reference directions X, Y, respectively.

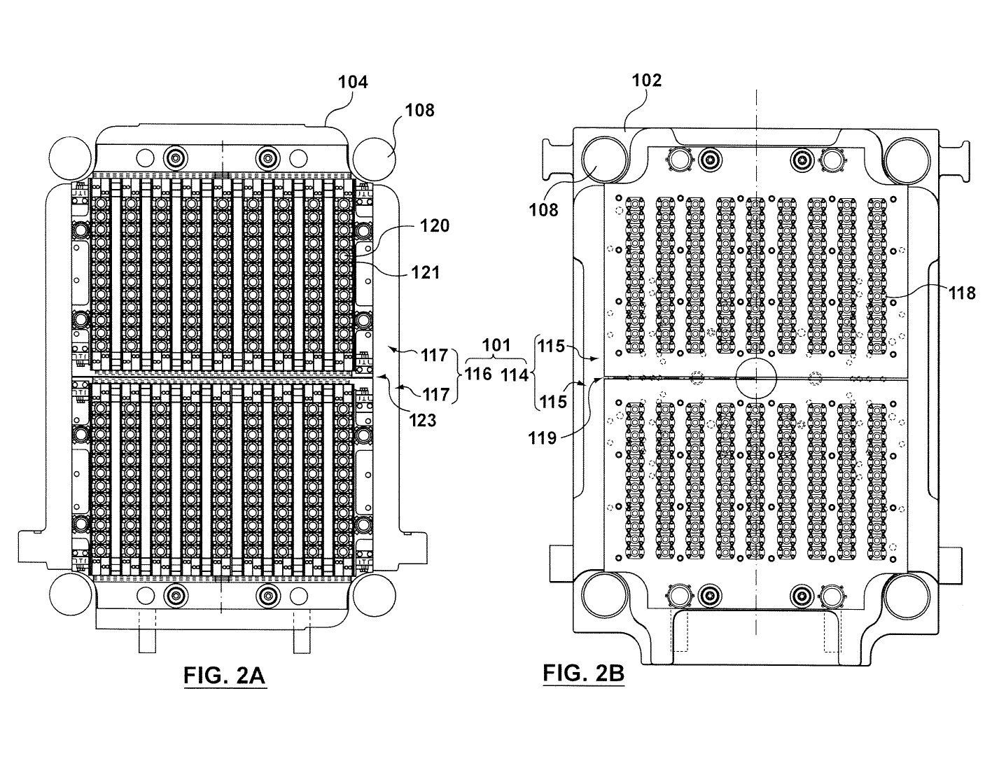

In accordance with another aspect of the present invention a mold 101 is provided, with at least one of a first mold assembly 114, a second mold assembly 116, or a mold runner system 149, 349 of the mold 101 is split between a set of substantially structurally independent mold modules. In accordance with the non-limiting embodiment of FIGS. 2A, 2B, the mold 101 includes a first mold assembly 114 and a second mold assembly 116. The first mold assembly 114 and the second mold assembly 116 include a plurality of first mold inserts 118 and second mold inserts 120, respectively, for defining a plurality of substantially identical molding cavities therebetween. With reference to FIG. 3A, the first mold assembly 114 is split between a set of first mold modules 115. Each first mold module 115 within the set of first mold modules 115 includes a first mold insert module 140 having a first mold base module 142 for accepting a subset of the plurality of first mold inserts 118. The first mold base module 142 of each first mold module 115 within the set of first mold modules 115 being substantially structurally independent with respect to each other. With reference to FIG. 3B, the second mold assembly 116 is also split between a set of second mold modules 117. Each second mold module 117 within the set of second mold modules 117 includes a second mold insert module 191 having a second mold base module 192 for accepting a subset of the plurality of second mold inserts 120. The second mold base module 192 of each second mold module 117 within the set of second mold modules 117 being substantially structurally independent with respect to each other.

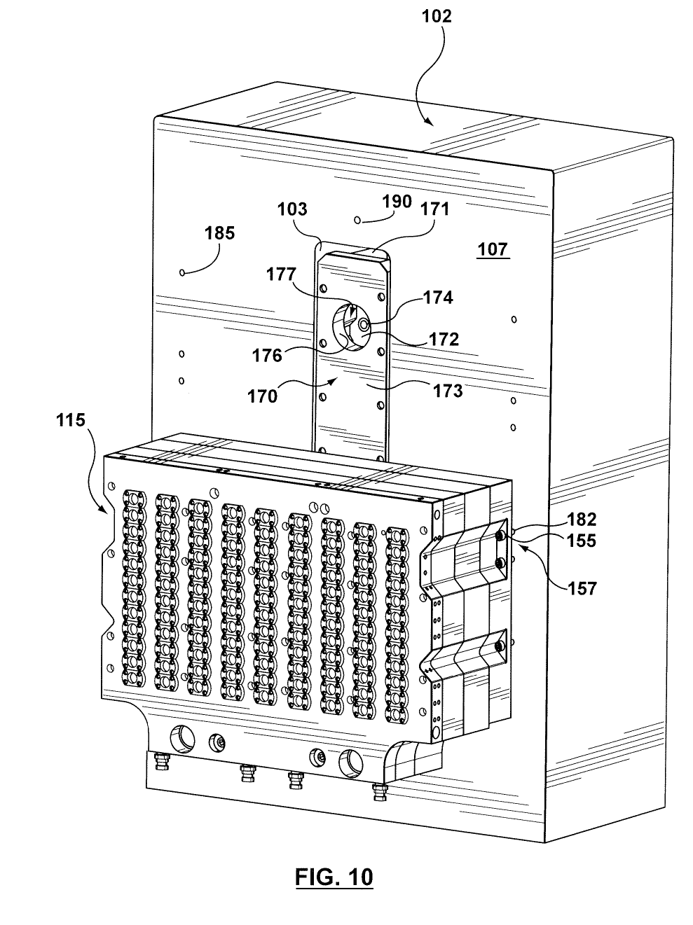

With reference to FIGS. 2A, 2B, and 10, the stationary and movable platens 102, 104 are configured to accept, in use, the set of substantially structurally independent first mold modules 115 of the first mold assembly 114 and the set of substantially structurally independent second mold modules 117 of the second mold assembly 116, respectively.

With reference to FIGS. 3A, 6, 7, 10 and 11, the runner system 148 embodying the network of runners 201, as described previously, is split between a mold runner system 149 and a bridge runner system 170. Further, the mold runner system 149 is split between a set of substantially structurally independent mold runner system modules 150, and each first mold module 115 of the set of first mold modules 115 includes a mold runner system module 150 of the set of mold runner system modules 150. In accordance with the non-limiting embodiment of the present invention, the network of runners 201 is split between a bridge network of runners 205 and a mold network of runners 206. The bridge network of runners 205 has a subset of the network of runners 201. The subset of the network of runners 201 includes the branch and drop runners of the first and second tier S1, S2 of the six or seven-tier cascade. The bridge network of runners 205 is arranged in the bridge runner system 170. The mold network of runners 206 has a subset of the network of runners 201. The subset of the network of runners 201 includes the branch and drop runners of the remainder tiers S3′, S4′, S5′, S6′, or S3, S4, S5, S6, S7, of the six or seven-tier cascade, respectively. The mold network of runners 206 is arranged in the set of mold runner system modules 150. Each mold runner system module 150 includes a third mold base module 151 for accepting a subset of runners of the mold network of runners 206. The third mold base module 151 of each first mold module 115 of the set of first mold modules 115 being substantially structurally independent with respect to each other. The subset of runners of the mold network of runners 206 for fluidly connecting the source of molding material with the subset of the plurality of first mold inserts 118 of the first mold insert module 140.

In accordance with the non-limiting embodiment the set of mold runner system modules 150 is a pair, each of the mold runner system modules 150 having one-hundred and twenty-eight melt outlets 270 arranged in a rectangular array having the first number of melt outlets 270 in the first reference direction X being nine and the second number of melt outlets 270 in the second reference direction Y being twelve, and such that the mold runner system modules 150 when arranged in a stacked arrangement on the stationary platen 102 provides the nine by twenty-four rectangular array of melt outlets 270 having two-hundred and sixteen melt outlets 270.

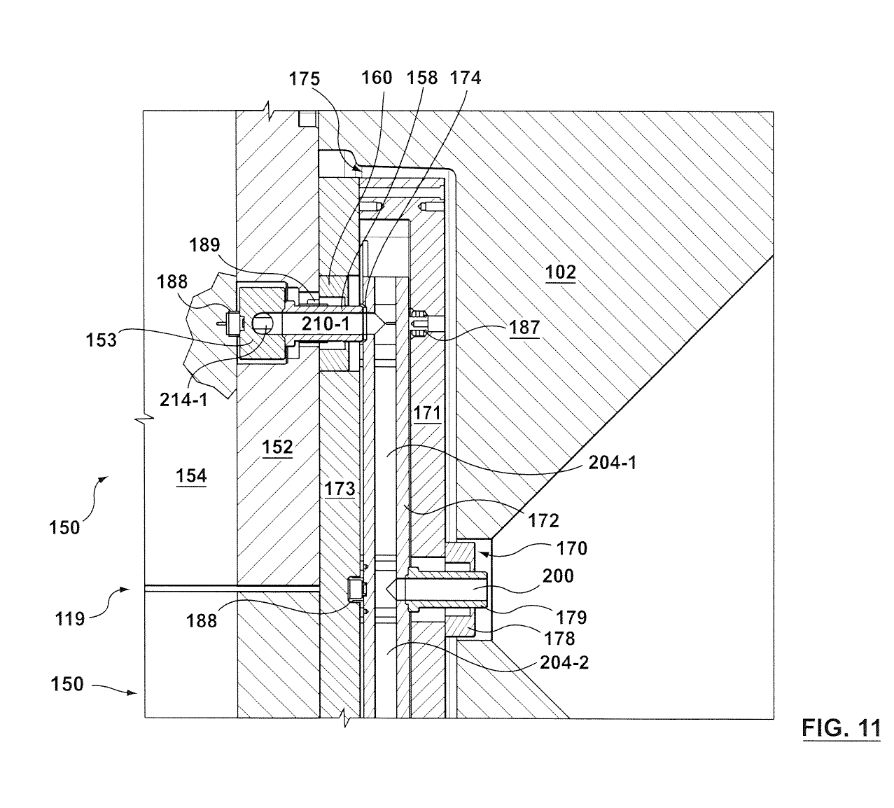

With reference to FIGS. 3A and 11, the third mold base module 151 includes a back plate 152, a manifold plate 156, and an air plate 154. The back plate 152 and the manifold plate 156 are configured to accept one or more mold module manifold 153 therebetween. The mold module manifold 153 defines a runner 214-1 of the subset of runners of the mold network of runners 206. The air plate 154 is configured to accept a set of valve gate actuators (not shown) with which to control a melt flow through the subset of runners of the mold module network of runners 206. The mold runner system module 150 is also configured to accept a mold module sprue 158. The mold module sprue 158 defines a runner 210-1 of the subset of runners of the mold network of runners 206 for fluidly connecting with the source of molding material.

The mold module sprue 158 is further configured to couple with the bridge runner system 170. The bridge runner system 170 defines the bridge network of runners 205, of the network of runners 201, to provide a fluid connection between the source of molding material and the runner 210-1 of the mold module sprue 158.

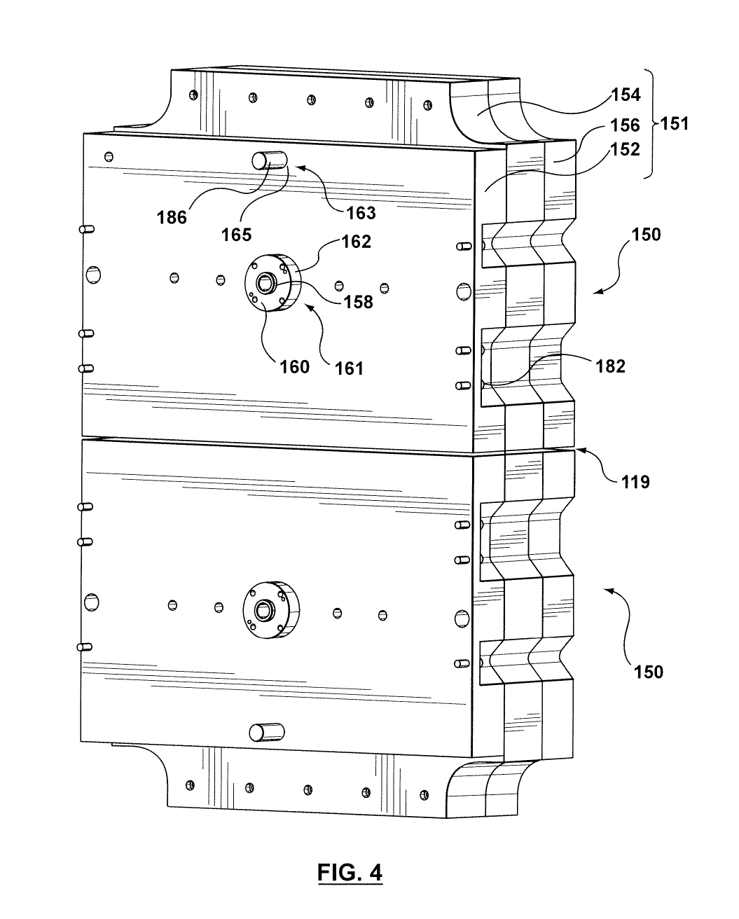

With reference to FIG. 4, the mold runner system module 150 includes a bridge locating structure 160 defining a locating surface 162 that is configured to cooperate with a complementary locating surface 176 (FIG. 10) defined by the bridge runner system 170 to align the runner 210-1 of the mold module sprue 158 with a runner 204-1 of the bridge network of runners 205.

In accordance with another aspect of the present invention a stationary platen 102 of a mold clamp unit 111 for use with a molding system 100 is provided, the stationary platen 102 includes a platen base 105 configured to accept a first mold assembly 114 of a mold 101, the platen base 105 defining a receptacle 103 for embedding, in use, a bridge runner system 170 that is configured to fluidly connect a source of molding material with a molding cavity defined, at least in part, by a first mold insert 118 accepted in the first mold assembly 114.

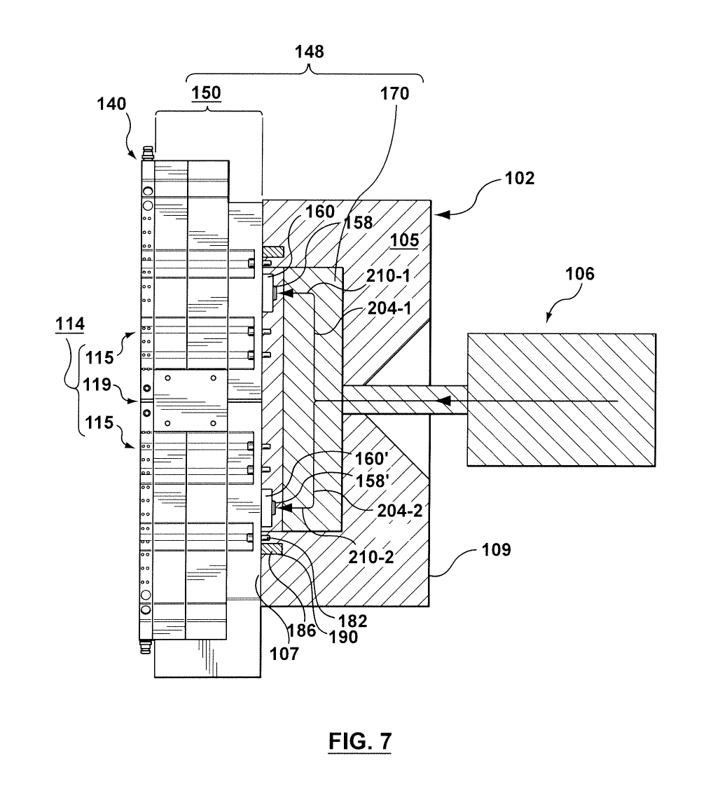

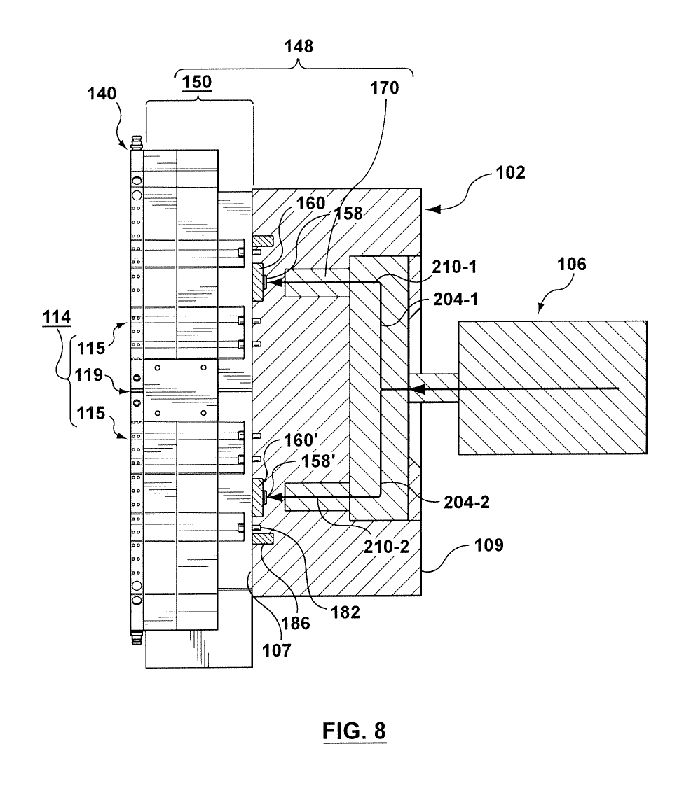

In accordance with the non-limiting embodiment of FIGS. 7, 8, 10, and 11 the bridge runner system 170 is embedded in the stationary platen 102 of the molding system 100, and the mold module sprue 158 is configured to couple with the bridge runner system 170. With reference to FIG. 10, and as schematically represented in FIG. 7, the bridge runner system 170 may be arranged in the receptacle 103 defined through a front face 107 of the the stationary platen 102. Alternatively, the receptacle 103 may be defined through a rear face 109 of the stationary platen 102, and as schematically represented in FIG. 8, or the receptacle 103 may be enclosed between (not shown) the front face 107 and the rear face 109 of the stationary platen 102.

With reference to FIGS. 4, 10 and 11, the bridge runner system 170 includes one or more bridge manifold 172 defines the bridge network of runners 205. The bridge runner system 170 also includes a housing 175 that is configured to accept the bridge manifold 172. The housing 175 includes a box plate 171 having a removable cover 173. The housing 175 defines the set of locating surfaces 176 for cooperating, in use, with the complementary set of locating surfaces 162 of the set of mold runner system modules 150. The bridge manifold 172 is configured to couple, in use, with a mold module sprue 158 of each the set of mold runner system modules 150. A seal member 174 may be disposed between the bridge manifold 172 and the mold module sprue 158. With reference to FIG. 11, an insulator 188 is disposed between the bridge manifold 172 and the removable cover 173 of the housing 175 to thermally isolate the bridge manifold 172 from the housing 175. In addition, a biasing member 187 is disposed between the bridge manifold 172 and the housing 175 to maintain, in use, the coupling between the bridge manifold 172 and the mold module sprue 158 of each the set of mold runner system modules 150. The biasing member 187 may include, for example, one of actuator or a spring. The bridge runner system 170 also includes a platen locating ring 178 on the rear of the housing 175. The platen locating ring 178 is configured to cooperate, in use, with an opening in a stationary platen 102 of the molding system 100.

With reference to FIGS. 4 and 10, a platen coupling interface (not numbered) is defined on the first mold assembly 114 for releasably securing, in use, the first mold assembly 114 to the stationary platen 102 having the bridge runner system 170 embedded therein. The platen coupling interface includes a platen mounting interface 157 configured to cooperate, in use, with a complementary mold mounting interface 185 associated with the stationary platen 102 for releasably mounting the first mold assembly 114 to the stationary platen 102. The platen coupling interface also includes a bridge runner system coupling interface 161 configured to cooperate, in use, with a mold runner system coupling interface 177 defined, at least in part, by the bridge runner system 170 for fluid connecting the mold network of runners 206 defined in the first mold assembly 114 with the bridge network of runners 205 defined in the bridge runner system 170. The platen coupling interface also includes a platen alignment interface 163 configured to cooperate, in use, with a complementary mold alignment interface 190 associated with the stationary platen 102 for arranging the first mold assembly 114 in a predetermined angular orientation on the stationary platen 102 and includes aligning adjacent first mold modules 115 of the set of first mold modules 115.

With reference to FIGS. 4, 7, 8, 9, and 10 the platen mounting interface 157 includes a fastener 182 engaged within a fastener seat 155, and the mold mounting interface 185 is configured to cooperate with the fastener 182. The bridge runner system coupling interface 161 includes the locating surface 162 defined on the bridge locating structure 160 of the first mold assembly 114, and a surface of the mold module sprue 158 of the mold runner system 149. The mold runner system coupling interface 177 includes a locating surface 176 defined on a housing 175 of the bridge runner system 170), and a surface of the bridge manifold 172 in the bridge runner system 170. The locating surfaces 162, 176 cooperating, in use, to align a runner 210-1 of the mold module sprue 158 with a runner 204-1 of the bridge manifold 172, and a seal member 174 between the surfaces of the mold module sprue 158 and the bridge manifold 172. The platen alignment interface 163 includes an outer surface of an alignment structure 186 (e.g. dowel), protruding from an alignment structure seat 165 (e.g. bore), and the mold alignment interface 190 (e.g. bore) is configured to cooperate with the alignment structure 186. The third mold base module 151 of each first mold module 115 of the set of first mold modules 115 defines an instance of the platen mounting interface 157, the bridge runner system coupling interface 161, and the platen alignment interface 163.

With reference to FIG. 3B, each second mold module 117 of the set of second mold modules 117 also includes a third mold insert module 193. The third mold insert module 193 includes a fifth mold base module 194 for accepting a subset of a plurality of third mold inserts 121. The plurality of third mold inserts 121 are configured to cooperate with the first and second mold inserts 118, 120 in defining the plurality of molding cavities. The fifth mold base module 194 of each second mold module 117 of the set of second mold modules 117 being substantially structurally independent with respect to each other. The third mold insert 121 are coupled, in use, between a slide pair 197 of slide bars 198, 198′. The slide pair 197 cooperates with a cam 181 for moving the slide bars 198, 198′ towards and away from each other for opening and closing the complementary halves of each third mold insert 121 with respect to each other.

For greater certainty, in the foregoing non-limiting embodiment of the invention, each of the first mold base module 142, second mold base module 192, third mold base module 151, and fifth mold base module 194 within the sets of first mold insert modules 140, second mold insert modules 191, mold runner system modules 150, and third mold insert modules 193, respectively, are substantially structurally independent by virtue of each comprising a separate plate. The plate may be made from any suitable material that is known to be compatible for use as a mold base, such as, for example, AISI (American Iron and Steel Institute) Grade 420 stainless steel.

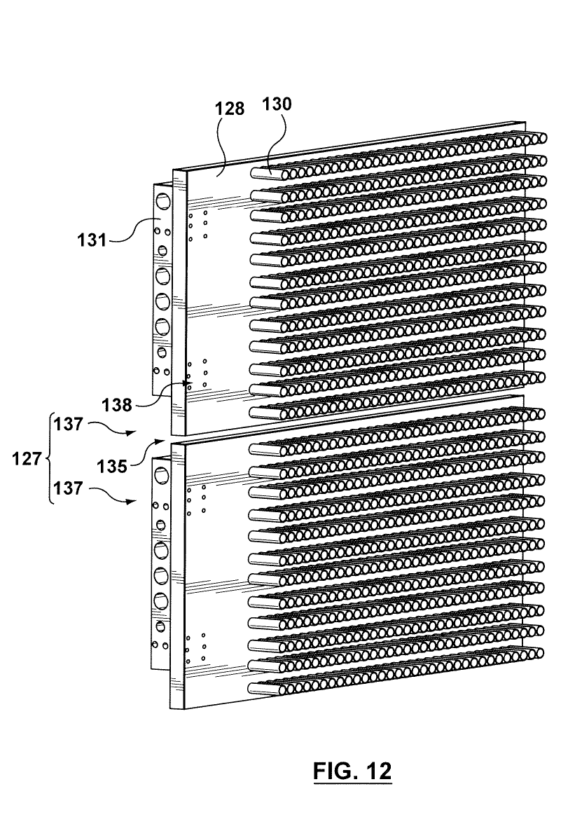

In accordance with the non-limiting embodiment of FIGS. 1 and 12, the molding system 100 also includes an end-of-arm tool 127 that includes a set of substantially structurally independent end-of-arm tool modules 137. Each end-of-arm tool module 137 of the set of end-of-arm tool modules 137 includes a mounting interface 137 that is configured to cooperate with a complementary mounting interface (not shown) on the actuating arm 126 for coupling, in use, the end-of-arm tool module 137 with the actuating arm 126 of the robot 122. Each end-of-arm tool module 137 of the set of end-of-arm tool modules 137 is configured to accept, in use, a subset of the plurality of molded article receptacles 130. Each end-of-arm tool module 137 of the set of end-of-arm tool modules 137 includes an end-of-arm tool base module 128 for accepting the subset of the plurality of molded article receptacles 130. The end-of-arm tool base module 128 of each of the set of end-of-arm tool modules 137 being substantially structurally independent with respect to each other. The plurality of molded article receptacles 130 is a multiple of a plurality of molding cavities of the mold 101. Each end-of-arm tool module 137 of the set of end-of-arm tool modules 137 further includes a services manifold 131 for fluidly connecting, in use, the subset of molded article receptacles 130 with a source and sink for coolant, as well a air pressure and vacuum source.

For greater certainty, in the foregoing non-limiting embodiment of the invention, each of the end-of-arm tool base module 128 within the set of end-of-arm tool modules 137 are substantially structurally independent by virtue of each comprising a separate plate. The plate may be made from any suitable material that is known to be compatible for use as an end-of-arm tool base, such as, for example, Aluminum plate of Alloy Grade 6061.

With a further non-limiting embodiment of the present invention (not shown), the end-of-arm tool 127 includes a plurality of molded article receptacles 130 that is the same quantity as a plurality of molding cavities defined in the mold 101.

In accordance with the non-limiting embodiment of FIGS. 2A, 2B, the mold 101 is configured to produce preforms 2 of the type for blow molding into a bottle. Accordingly, each of the plurality of first mold inserts 118 define a cavity for forming a first outer portion of a preform, each of the plurality of second mold inserts 120 define a core for forming an inner portion of the preform, and each of the plurality of third mold inserts 121 define pairs of split mold inserts for forming a second outer portion of the preform. Accordingly, the first mold base module 142 is a cavity plate, second mold base module 192 is a core plate, the fifth mold base module 194 is a stripper plate, and the end-of-arm tool base module 128 is a carrier plate.

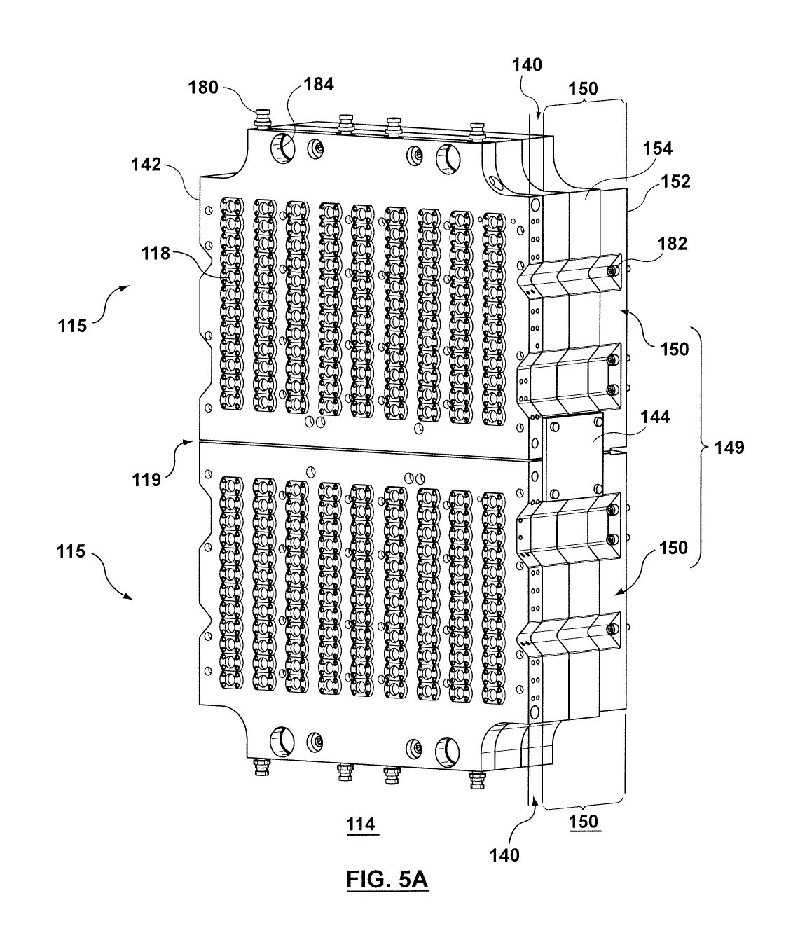

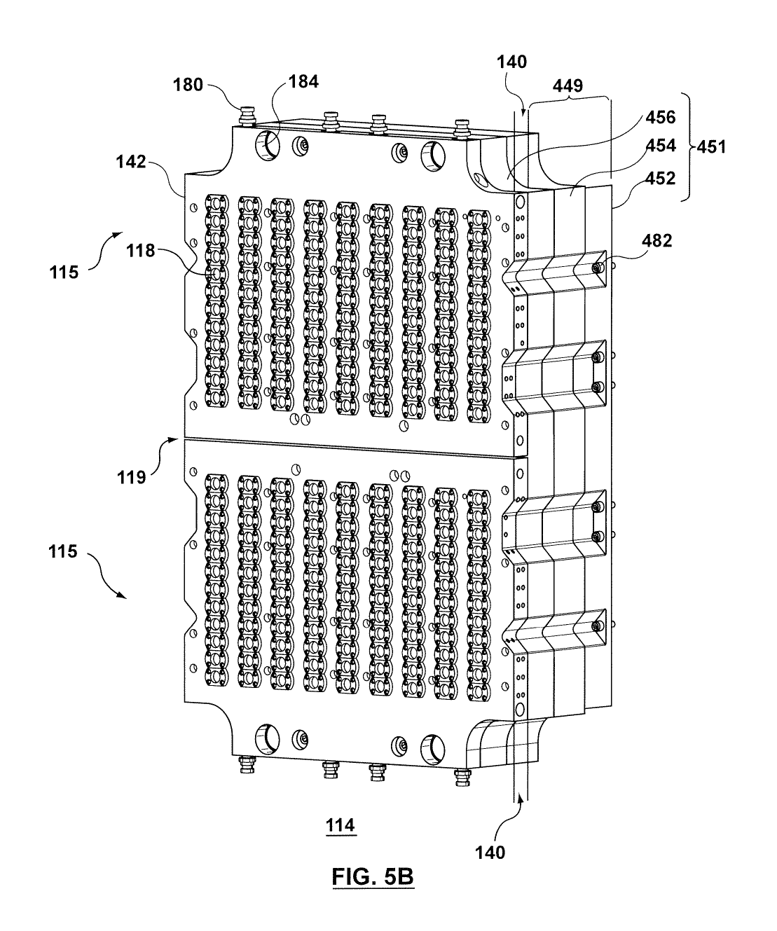

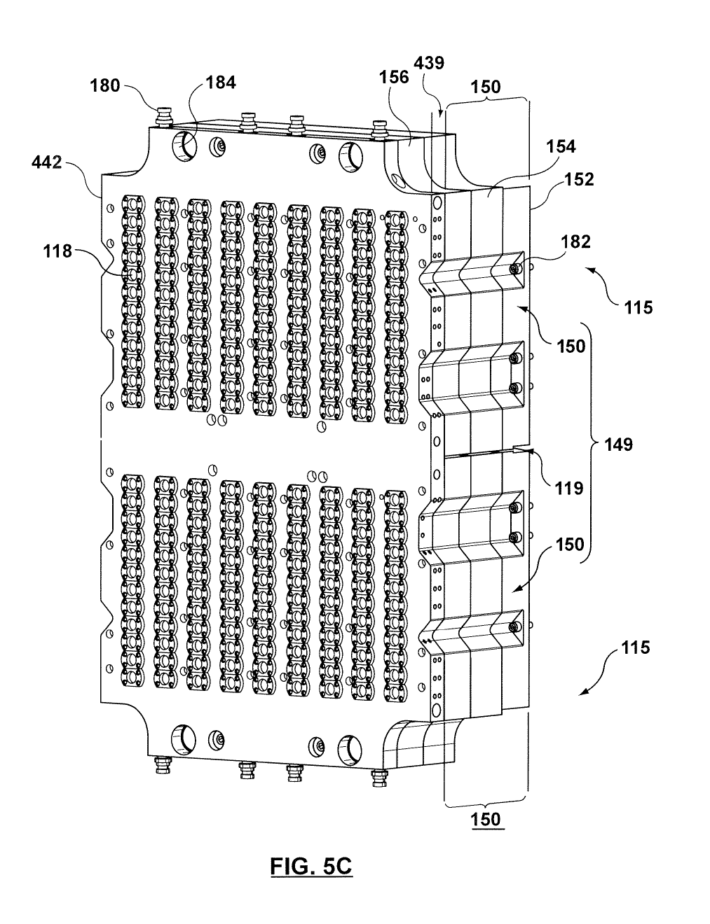

In accordance with a further non-limiting embodiments of the present invention, the set of first mold modules 115 may include one or both of the first mold insert module 140 and/or the mold runner system module 150. For example, within another non-limiting embodiment in accordance with FIG. 5B, the set of first mold modules 115 do not include the set of mold runner system modules 150 and instead the first mold assembly 114 has a mold runner system 449 having a common sixth mold base 451 upon which the set of first mold insert modules 140 are mounted. Alternatively, for example, within yet another non-limiting embodiment in accordance with FIG. 5C, the set of first mold modules 115 include only the set of first mold insert modules 140 and a mold insert assembly 439 having a common base 442 is provided upon which the set of mold runner system modules 150 are mounted.

In accordance with a further non-limiting embodiment (not shown) any other commonly known network of runners (not shown) may be split between the set of mold runner system modules 150.

Within another non-limiting embodiment (not shown), the first mold assembly 114 is split between the set of substantially structurally independent first mold modules 115 (FIG. 3A) whereas the second mold assembly 116 is a structurally integrated assembly (not shown), that is, not split, with the plurality of second inserts 120 of the second mold assembly 116 accepted in a common base (not shown).

In accordance with the non-limiting embodiment of FIGS. 2A, 2B, the sets of first and second mold modules 115, 117 each include a pair of the first mold module 115, and the second mold module 117, respectively. Alternatively, one or both of the sets of first and second mold modules 115, 117, may include a number of the first mold modules 115, and second mold modules 117, respectively, in excess of a pair. For example, one or both of the sets of first and second mold modules 115, 117 may include three of the first and/or second mold modules 115, 117, respectively.

In accordance with the non-limiting embodiment of FIGS. 2A, 2B the plurality of first mold inserts 118 and second mold inserts 120 are split equally between the modules within the set of first mold modules 115 and second mold modules 117, respectively. Accordingly, each of the first and second mold modules 115, 117 within the respective sets of first and second mold modules 115, 117 are configured to be substantially the same with respect to each other.

Within another non-limiting embodiment (not shown), the plurality of first mold inserts 118 and second mold inserts 120 may be split unequally between the respective set of first mold modules 115 and second mold modules 117, respectively. Accordingly, each of the first and second mold modules 115, 117 within the respective sets of first and second mold modules 115, 117 may be configured differently with respect to each other.

Within the non-limiting embodiment in accordance with FIGS. 2A, 2B a first mold module interface 119 and a second mold module interface 123 are defined between adjacent first mold modules 115 of the set of first mold modules 115 and second mold modules 117 within the set of first mold modules 115 and second mold modules 117, respectively. In the non-limiting embodiment the set of first mold modules 115 and second mold modules 117 are arranged on the stationary platen 102 and the movable platen 104, respectively, in a vertically stacked relation, and hence, the first and second mold module interfaces 119, 123 are generally horizontal. The first mold module interface 119 and second mold module interface 123 within the non-limiting embodiment is simply a gap between the adjacent first mold modules 115 and second mold modules 117, respectively.

Within another non-limiting embodiments (not shown), the sets of first and second mold modules 115, 117 may be differently arranged on the stationary platen 102, and movable platen 104, respectively, the first and second mold interfaces 119, 123 are vertical or diagonal, and the like.

Within another non-limiting embodiments (not shown), the adjacent first and second mold modules 115, 117 may substantially abut such that there is substantially no gap at the first and second mold interfaces 119, 123 each second mold module 117 of the set of second mold modules

Within another non-limiting embodiment (not shown), a services manifold (not shown) is provided at one or both of the first and second mold module interfaces 119, 123 to connect at least one service between adjacent first mold modules 115 or adjacent second mold modules 117, respectively.

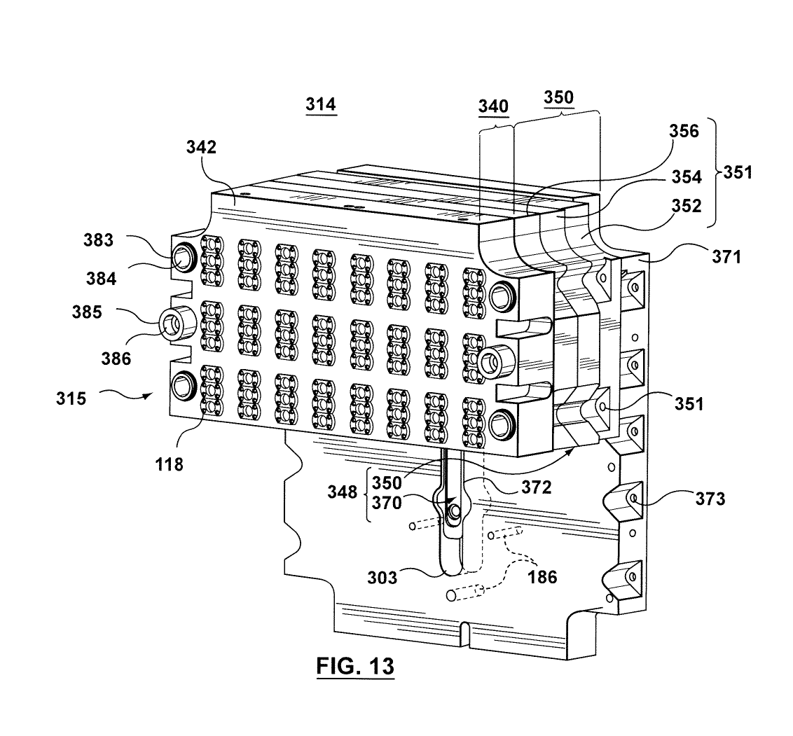

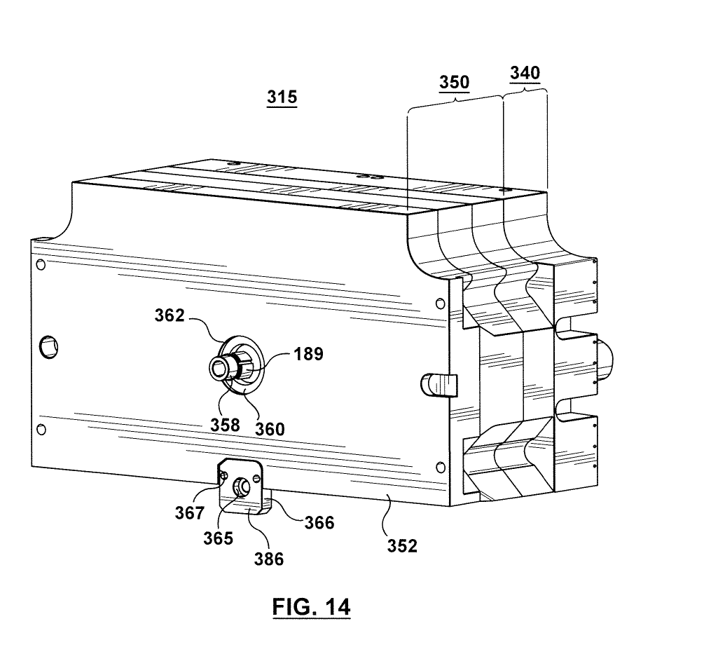

Within another non-limiting embodiment in accordance with FIGS. 13, 14, & 15, the mold 101 includes a first mold assembly 314 (only a first mold module 315 of which is shown in FIGS. 13 & 14), and a second mold assembly (only a second mold module 317 of which is shown in FIG. 15). The first and second mold module 315, 317 of FIGS. 13, 14, and 15 are substantially similar to the first and second mold module 115, 117 of FIGS. 2A, 2B, 3A, and 3B and, as such, like elements are depicted with like numerals. The first and second mold module 315, 317 have a different number and layout of first, second and third mold inserts 118, 120, 121, respectively. A further difference includes the bridge runner system 370 embedded with the first mold assembly 314. The bridge runner system 370 is similar to the bridge runner system 170 described previously for linking together a set of mold runner systems 350 of the set of first mold modules 315. The bridge runner system 370 is however unique in that it is configured to be embedded in a fourth mold base module 371 of the first mold assembly 314. Accordingly, the fourth mold base module 371 is configured to have the set of first mold modules 315 mounted thereto. Another difference includes a distinct slide pair 397 arrangement such that the second mold module 317 includes the plurality of third mold insert 121 coupled, in use, between a slide pair 397 of slide bars 398, 398′. The slide pair 397 cooperate with a cam 381 for moving the slide bars 398, 398′ towards and away from each other for opening and closing the complementary halves of each third mold insert 121 with respect to each other. In addition, the first and second mold module 315, 317 include complementary first and second mold module alignment structures 385, 387 (FIGS. 13 and 15), respectively, that include complementary alignment tapers 386, 388, that cooperate, in use, in aligning the first and second mold modules 315, 317 when the mold 101 is closed.

Within another non-limiting embodiment in accordance with FIG. 5A, the first mold base module 142 and/or the third mold base module 151 of adjacent first mold modules 115 of the set of first mold modules 115 are configured to cooperate with a latching structure 144. The latching structure 144 latch together adjacent first mold modules 115, 315 as may be convenient for handling the set of first mold modules 115, or portions thereof, when hanging or servicing the first mold assembly 114 on the stationary platen 102 of the molding system 100.

Within another non-limiting embodiment in accordance with FIG. 14, the alignment structure 386 may comprise a rectangular plate having sides that are configured to provide a pair of alignment surfaces 366. The alignment surfaces 366 cooperate, in use, with a complementary pair of alignment surfaces 367 provided by sides of a cavity formed through a back face of the first mold module 315. The alignment structure 386 also includes an insulator surface 365 that is configured to cooperate with an insulator (not shown) of the bridge runner system 350.

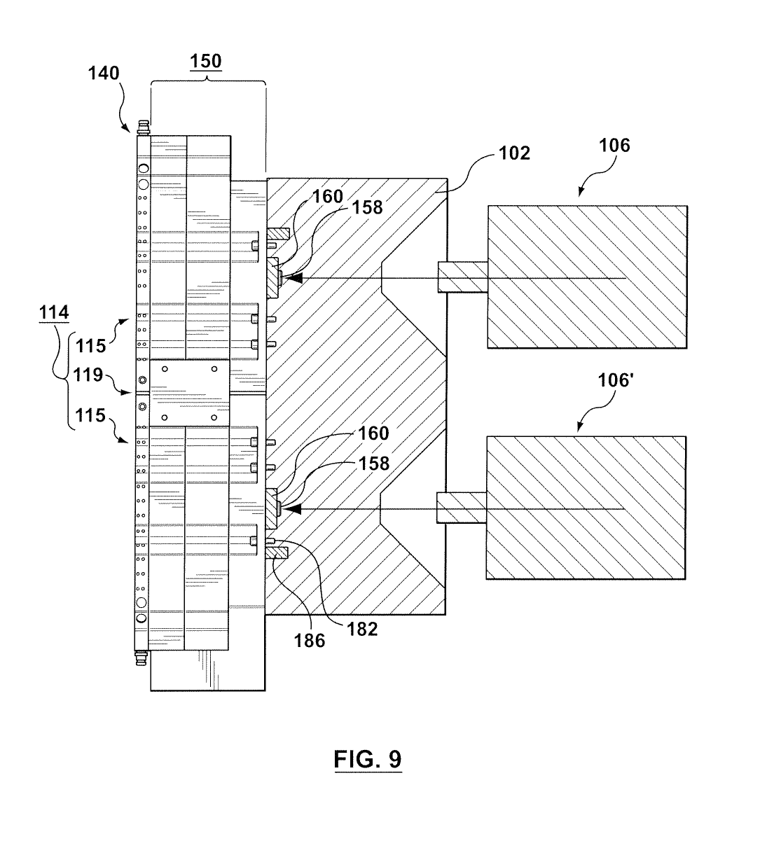

Within another non-limiting embodiment in accordance with FIG. 9, the bridge runner system 170, and the related bridge network of runners 205, are replaced by the use of a pair of injection units 106, 106′.

Within another non-limiting embodiment (not shown), a stationary platen 102 with an embedded bridge runner system (not shown) is provided such that the bridge runner system defines the entire network of runners 201 with one of the mold insert assembly 439 or the set of first mold inset modules 140 mountable, in use, directly to the front face of the stationary platen 102 and/or the bridge runner system embedded therein.

Within another non-limiting embodiment (not shown) the first mold base module 142 of each first mold module 115 of the set of first mold modules 115 defining, at least in part, the platen mounting interface 157, the bridge runner system coupling interface 161, and the platen alignment interface 163.

A technical effect of splitting at least one the first mold assembly 114, 314, the second mold assembly 116, or the end-of-arm tool 127 between a set of first mold modules 115, 315, a set of second mold modules 117, 317, or a set of end-of-arm tool modules 137 may include, amongst others, simplified manufacturing and/or simplified installation of a mold 101 and/or end-of-arm tool 127 in the molding system 100. For example, without implementing the present invention it is considered impractical to economically manufacture and handle a mold 101 and end-of-arm tool having two-hundred and sixteen molding cavities and holders, respectively. That being said, the invention may bring similar economy to the other classes of injection molds and end-of-arm tools, large or small.

A technical effect of embedding the bridge runner system 170 within the stationary platen 102 may include, amongst others, a reduction in a shut height of the mold 101.

The concepts described above may be adapted for specific conditions and/or functions, and may be further extended to a variety of other applications that are within the scope of the present invention. Having thus described the embodiments, it will be apparent that modifications and enhancements are possible without departing from the concepts as described. Therefore, what is to be protected by way of letters patent are limited only by the scope of the following claims:

1. A stationary platen of a mold clamp for use with a molding system, comprising:
a platen base configured to accept a first mold assembly of a mold, the platen base defining a receptacle for embedding, in use, a bridge runner system that is configured to fluidly connect, at least in part, a source of molding material with a molding cavity defined, at least in part, by a mold insert accepted in the first mold assembly.

2. The stationary platen according to claim 1, wherein:
the platen base configured to accept, in use, a set of substantially structurally independent first mold modules of the first mold assembly mounted thereto.

3. The stationary platen according to claim 1, further comprising:
the bridge runner system.

4. The stationary platen according to claim 3, wherein:
the bridge runner system configured to define a bridge network of runners with which to fluidly connect, in use, the source of molding material with a mold network of runners that are arranged in a set of mold runner system modules of the set of first mold modules.

5. The stationary platen according to claim 4, wherein:
the bridge runner system includes a bridge manifold defines the bridge network of runners.

6. The stationary platen according to claim 5, wherein:
the bridge manifold is configured to couple, in use, with a mold module sprue of each the set of mold runner system modules.

7. The stationary platen according to claim 5, wherein:
the bridge runner system includes a housing configured to accept the bridge manifold.

8. The stationary platen according to claim 7, wherein:
the housing includes a platen locating ring that is configured to cooperate, in use, with an opening in the stationary platen.

9. The stationary platen according to claim 7, wherein:
the housing defines a set of locating surfaces for cooperating, in use, with a complementary set of locating surfaces of the set of mold runner system modules, to align a runner of the bridge network of runners with a runner of the mold network of runners.

10. The stationary platen according to claim 7, wherein:
the bridge runner system includes an insulator disposed between the bridge manifold and the housing to thermally isolate the bridge manifold from the housing, and a biasing member disposed between the bridge manifold and the housing to maintain, in use, the coupling between the bridge manifold and the mold module sprue of each the set of mold runner system modules.

11. The stationary platen according to claim 10, wherein:
the a biasing member includes one of actuator or a spring.

12. A molding system, comprising:
a stationary platen configured to accept, in use, a first mold assembly of a mold;
a movable platen configured to accept, in use, a second mold assembly of the mold;
a clamping mechanism configured to clamp, in use, the mold;
an injection unit 106 as a source of molding material for fluid connection, in use, with the mold; and
the stationary platen of a molding system, includes:
a platen base configured to accept the first mold assembly, the platen base defining a receptacle for embedding, in use, a bridge runner system that is configured to fluidly connect a source of molding material with the mold.

13. The molding system according to claim 12, wherein:
one of:
the receptacle defined through a front face of the stationary platen;
the receptacle defined through a rear face of the stationary platen; or
the receptacle enclosed between the front face and the rear face of the stationary platen.

14. The molding system according to claim 12, wherein:
the platen base configured to accept, in use, a set of substantially structurally independent first mold modules of the first mold assembly mounted thereto.

15. The molding system according to claim 12, further comprising:
the bridge runner system.

16. The molding system according to claim 15, wherein:
the bridge runner system configured to define a bridge network of runners with which to fluidly connect, in use, the source of molding material with a mold network of runners that are arranged in a set of mold runner system modules of the set of first mold modules.

17. The molding system according to claim 16, wherein:
the bridge runner system includes a bridge manifold defines the bridge network of runners.

18. The molding system according to claim 17, wherein:
the bridge manifold is configured to couple, in use, with a mold module sprue of each the set of mold runner system modules.

19. The molding system according to claim 17, wherein:
the bridge runner system includes a housing configured to accept the bridge manifold.

20. The molding system according to claim 19, wherein:
the housing includes a platen locating ring that is configured to cooperate, in use, with an opening in the stationary platen.

21. The molding system according to claim 19, wherein:
the housing defines a set of locating surfaces for cooperating, in use, with a complementary set of locating surfaces of the set of mold runner system modules, to align a runner of the bridge network of runners with a runner of the mold network of runners.

22. The molding system according to claim 19, wherein:
the bridge runner system includes an insulator disposed between the bridge manifold and the housing to thermally isolate the bridge manifold from the housing, and a biasing member disposed between the bridge manifold and the housing to maintain, in use, the coupling between the bridge manifold and the mold module sprue of each the set of mold runner system modules.

23. The molding system according to claim 22, wherein:
the a biasing member includes one of actuator or a spring.

24. A bridge runner system, comprising:
a bridge network of runners configured to fluidly connect, in use, a source of molding material with a mold network of runners;
the bridge network of runners configured to be embedded, in use, in a stationary platen of the molding system.

25. The bridge runner system according to claim 24, further comprising:
a bridge manifold defines the bridge network of runners.

26. The bridge runner system according to claim 25, further comprising:
a housing configured to accept the bridge manifold.

27. The bridge runner system according to claim 26, wherein:
the housing defines a locating surface for cooperating, in use, with a complementary locating surface of a mold runner system, to align a runner of the bridge network of runners with a runner of the mold network of runners accepted in the mold runner system.

28. The bridge runner system according to claim 26, wherein:
the bridge manifold is configured to couple, in use, with a mold module sprue of the mold runner system.

29. The bridge runner system according to claim 28, wherein:
a seal member is disposed between the bridge manifold and the mold module sprue.

30. The bridge runner system according to claim 28, further comprising:
an insulator is disposed between the bridge manifold and the housing to thermally isolate the bridge manifold from the housing, and a biasing member disposed between the bridge manifold and the housing to maintain, in use, the coupling between the bridge manifold and the mold module sprue of each the set of mold runner system modules.

31. The bridge runner system according to claim 30, wherein:
the a biasing member includes one of actuator or a spring.

32. The bridge runner system according to claim 26, further comprising:
a platen locating ring on the housing, the platen locating ring configured to cooperate, in use, with an opening in a stationary platen of a molding system.

33. A platen coupling interface defined on a first mold assembly of a mold for releasably securing, in use, the first mold assembly to a stationary platen of a molding system having a bridge runner system embedded therein, the platen coupling interface comprising:
a platen mounting interface configured to cooperate, in use, with a complementary mold mounting interface associated with the stationary platen for releasably mounting the first mold assembly to the stationary platen;
a bridge runner system coupling interface configured to cooperate, in use, with a mold runner system coupling interface defined, at least in part, by the bridge runner system for fluid connecting a mold network of runners defined in the first mold assembly with a bridge network of runners defined in the bridge runner system.

34. The platen coupling interface according to claim 33, further including:
a platen alignment interface configured to cooperate, in use, with a mold alignment interface associated with the stationary platen for arranging the first mold assembly in a predetermined angular orientation on the stationary platen.

35. The platen coupling interface according to claim 33, wherein:
the platen mounting interface includes a fastener engaged within a fastener seat, and wherein the mold mounting interface is configured to cooperate with the fastener.

36. The platen coupling interface according to claim 33, wherein:
the bridge runner system coupling interface includes:
a locating surface defined on a bridge locating structure of the first mold assembly; and
a surface of a mold module sprue of a mold runner system in the first mold assembly;
the mold runner system coupling interface includes:
a locating surface defined on a housing of the bridge runner system;
a surface of a bridge manifold in the bridge runner system;
the locating surfaces cooperating, in use, to align a runner of the mold module sprue with a runner of the bridge manifold, and a seal member between the surfaces of the mold module sprue and the bridge manifold.

37. The platen coupling interface according to claim 34, further including:
the platen alignment interface includes an outer surface of an alignment structure arranged in an alignment structure seat, and wherein the mold alignment interface is configured to cooperate with the alignment structure.

38. The platen coupling interface according to claim 34, wherein:
the first mold assembly is split between a set of substantially structurally independent first mold modules, each first mold module of the set of first mold modules includes an instance of the platen mounting interface, the bridge runner system coupling interface, and the platen alignment interface.

39. The platen coupling interface according to claim 38, wherein:
each first mold module of the set of first mold modules includes a first mold insert module having a first mold base module for accepting a subset of a plurality of first mold inserts;
the first mold base module of each first mold module of the set of first mold modules being substantially structurally independent with respect to each other; and
the first mold base module of each first mold module of the set of first mold modules defining, at least in part, the platen mounting interface, the bridge runner system coupling interface, and the platen alignment interface.

40. The platen coupling interface according to claim 38, wherein:
each first mold module of the set of first mold modules includes a mold runner system module having a third mold base module for accepting a subset of runners of the mold network of runners;
the third mold base module of each first mold module of the set of first mold modules being substantially structurally independent with respect to each other; and
the third mold base module of each first mold module of the set of first mold modules defining, at least in part, the platen mounting interface, the bridge runner system coupling interface, and the platen alignment interface.
